(19) United States
(12) Patent Application Publication
(10) Pub. No.: US 2013/0255276 A1
(43) Pub. Date: Oct. 3, 2013

(54) Transition Duct Mounting System

(71) Applicant: ALSTOM TECHNOLOGY LTD., Baden (CH)

(72) Inventors: Stephen W. Jorgensen, Palm City, FL (US); Joshua R. McNally, Stuart, FL (US); Hany Rizkalla, Stuart, FL (US)

(73) Assignee: Alstom Technology Ltd., Baden (CH)

(21) Appl. No.: 13/778,674

(22) Filed: Feb. 27, 2013

Related U.S. Application Data
(60) Provisional application No. 61/616,130, filed on Mar. 27, 2012.

(51) Int. Cl. F02C 7/20; F01D 25/24

(52) U.S. Cl. CPC F02C 7/20; F01D 25/243
USPC 60/796; 415/213.1

(57) ABSTRACT

The present invention is directed to a mounting system for a gas turbine transition duct. The mounting system includes a generally C-shaped mounting bracket having a generally radially extending first portion, an arc-shaped second portion, and a generally radially extending third portion. Each of the first portion and third portion includes a spherical bearing and the second portion has a plurality of sets of mounting holes. In another embodiment of the present invention, a gas turbine transition duct is provided having a panel assembly, an aft frame secured to the panel assembly and a mounting system for securing the transition duct to a turbine inlet. The panel assembly includes two formed sheets of metal secured together along axial seams. The panel assembly is secured to an aft frame that is capable of expanding in the circumferential direction due to thermal growth. The mounting system comprises a generally C-shaped mounting bracket having a generally radially extending first portion, an arc-shaped second portion, and a generally radially extending third portion. Each of the first portion and third portion includes a spherical bearing and the second portion has a plurality of sets of mounting holes.

### CROSS-REFERENCE TO RELATED APPLICATIONS

This application claims the benefit of U.S. Provisional Application No. 61/616,130, filed Mar. 27, 2012, entitled “Transition Duct Mounting System.” The entirety of the aforementioned application is incorporated by reference.

### TECHNICAL FIELD

The present invention generally relates to a mounting system for securing a transition duct to an inlet of a turbine and more specifically to a system and method for controlling the amount of movement of the aft end of the transition duct relative to the inlet of a turbine.

### BACKGROUND OF THE INVENTION

In a typical gas turbine engine used in a powerplant application, a plurality of combustors are arranged in an annular array about a centerline of the engine. The combustors receive pressurized air from the engine's compressor, add fuel to create a fuel/air mixture, and ignite the mixture to produce hot combustion gases. The hot combustion gases exit the combustors and enter a turbine, where the expanding gases are utilized to drive a turbine, which is in turn coupled through a shaft to the compressor. The engine shaft is also coupled to a shaft that drives a generator for generating electricity.

Due to the position of the combustors relative to the location of the turbine inlet, the hot combustion gases typically must be repositioned radially in order to enter the turbine. A transition duct is located between the exit of each combustion liner and the inlet of the turbine. The transition duct typically changes both in radial position and diameter as it extends between the combustor exit and the turbine inlet.

A transition duct and its mounting system in accordance with the prior art is shown in FIGS. 1 and 2. This prior art mounting system is similar to that of U.S. Pat. No. 6,662,567, which is hereby incorporated by reference. The transition duct 10 includes a mounting system 12, which includes two L-shaped mounting brackets 14. Each of the mounting brackets 14 provides pivot capability through a bearing 16. Also, the mounting brackets 14 include two oversized mounting holes 18. Through the bearing 16, mounting holes 18, and plurality of mounting brackets 14, the mounting system 12 was intended to provide increased flexibility for securing the transition duct 10 to the turbine inlet 20 by permitting movement relative to each mounting bracket 14. However, extended use of this mounting system has shown problems such as a rocking sensation created by the oversized mounting holes 18 and the excessive amount of play created between the multiple mounting brackets 14 and the turbine inlet 20. This excessive play and/or movement have created assembly and operational issues with the transition duct.

### SUMMARY

In accordance with the present invention, there is provided a novel and improved system and method for mounting a transition duct to a turbine inlet of a gas turbine engine. The present invention is directed towards a mounting system for a gas turbine transition duct. In a first embodiment, the mounting system comprises a generally C-shaped mounting bracket having a generally radially extending first portion, an arc-shaped second portion, and a generally radially extending third portion. Each of the first portion and third portion includes a spherical bearing and the second portion has a plurality of sets of mounting holes.

In another embodiment of the present invention, a gas turbine transition duct is provided comprising a panel assembly, an aft frame secured to the panel assembly and a mounting system for securing the transition duct to a turbine inlet. The panel assembly is comprised of two formed sheets of metal secured together along axial seams. The panel assembly is secured to an aft frame that is capable of expanding in the circumferential direction due to thermal growth. The mounting system comprises a generally C-shaped mounting bracket having a generally radially extending first portion, an arc-shaped second portion, and a generally radially extending third portion. Each of the first portion and third portion includes a spherical bearing and the second portion has a plurality of sets of mounting holes.

In yet another embodiment of the present invention, a mounting bracket for a gas turbine transition duct is provided comprising a generally C-shaped mounting bracket having a generally radially extending first portion, an arc-shaped second portion, and a generally radially extending third portion. A spherical bearing is located within both the first portion and third portion with a first set of mounting holes and a second set of mounting holes located along the second portion of the mounting bracket wherein the first set of mounting holes are spaced a first distance apart and the second set of mounting holes are spaced a second distance apart.

Additional advantages and features of the present invention will be set forth in part in a description which follows, and in part will become apparent to those skilled in the art upon examination of the following, or may be learned from practice of the invention. The instant invention will now be described with particular reference to the accompanying drawings.

### BRIEF DESCRIPTION OF THE SEVERAL VIEWS OF THE DRAWINGS

The present invention is described in detail below with reference to the attached drawing figures, wherein:

FIG. 1 is an exploded perspective view of the aft frame region and mounting system of a transition duct in accordance the prior art;

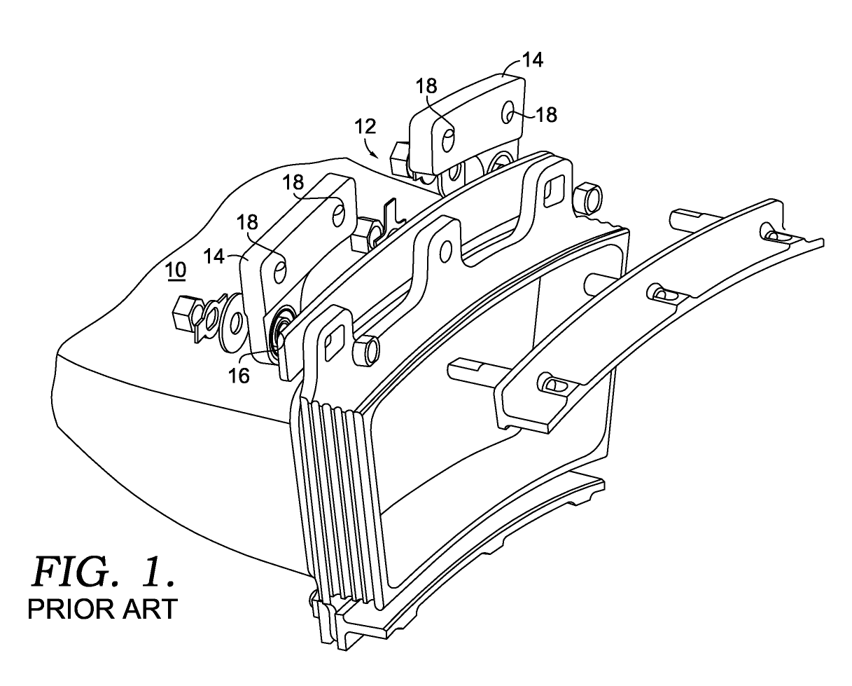

FIG. 2 is a perspective view of a portion of the mounting system of a transition duct secured to an inlet of a turbine in accordance with the prior art;

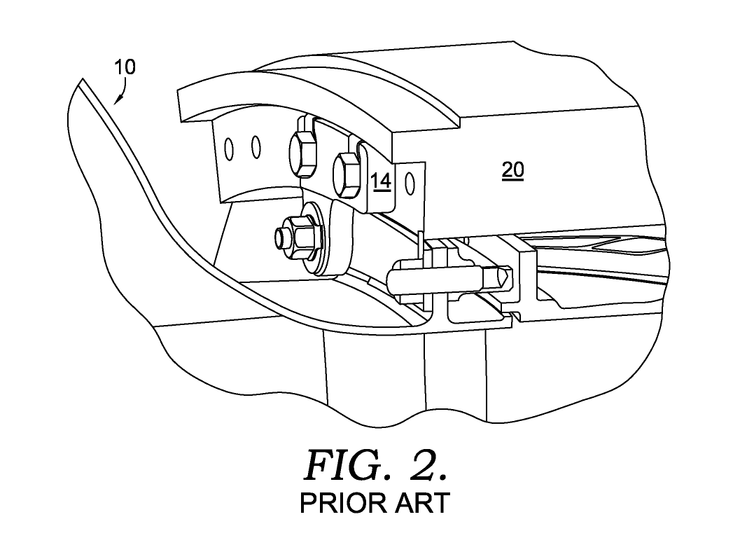

FIG. 3 is an exploded perspective view of the aft frame region and mounting system of a transition duct in accordance with an embodiment of the present invention;

FIG. 4 is an alternate exploded perspective view of the aft frame region and mounting system of a transition duct in accordance with an embodiment of the present invention;

FIG. 5 is a perspective view of the aft frame region and mounting system of a transition duct of FIG. 3 in accordance with an embodiment of the present invention; and

FIG. 6 is a perspective view of the aft frame region and mounting system of the transition duct of FIG. 4 in accordance with an embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different components, combinations of components, steps, or combinations of steps similar to the ones described in this document, in conjunction with other present or future technologies.

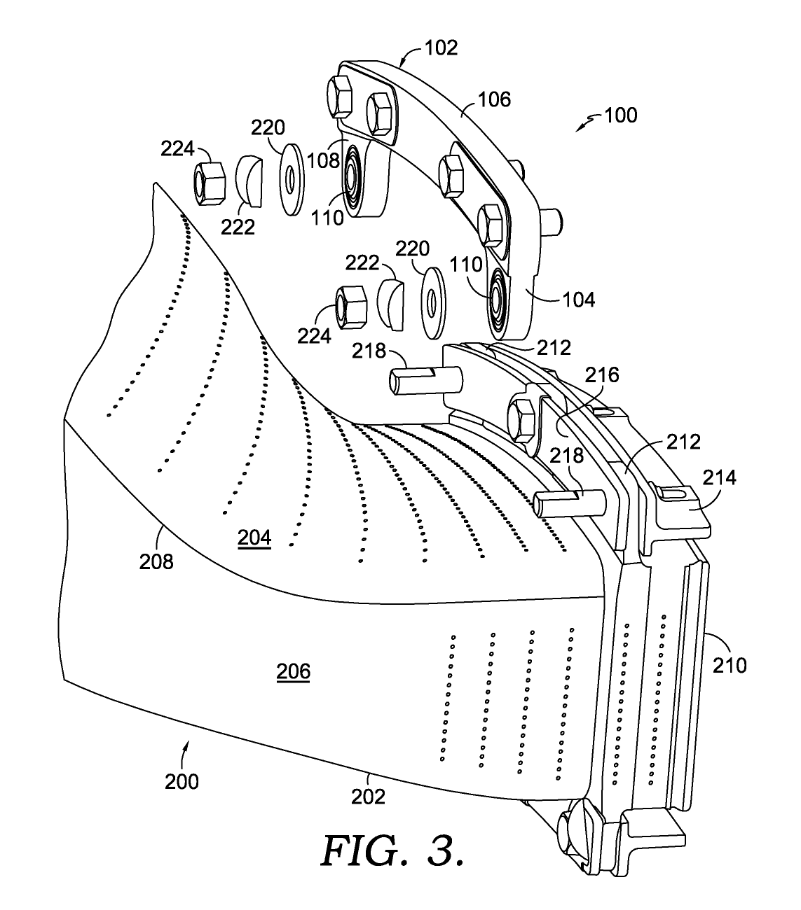

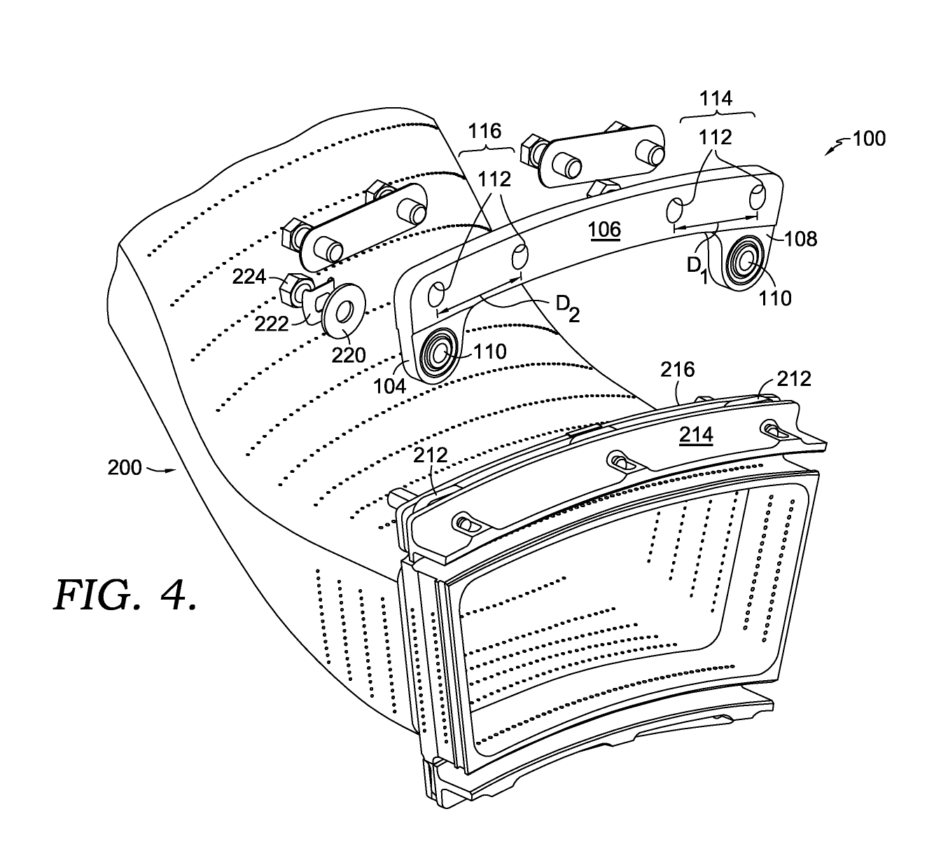

The present invention is shown in detail in FIGS. 3-6. Referring initially to FIGS. 3 and 4, various exploded views of a mounting system 100 are shown. The mounting system 100 comprises a generally C-shaped mounting bracket 102 having a generally radially extending first portion 104, an arc-shaped second portion 106, and a generally radially extending third portion 108. The first, second, and third portions are preferably fabricated from a single piece of forging or bar stock stainless steel. The first portion 104 and third portion 108 also comprise a spherical bearing 110. The spherical bearings 110 permits movement of the mounting bracket 102 relative to a transition duct 200.

The second portion 106 also includes a plurality of mounting holes 112. The mounting holes 112 are divided into a first set 114 and a second set 116. The holes of the first set are spaced a distance D1 apart while the holes of the second set are spaced a distance D2 apart. While two sets of mounting holes are shown in FIG. 4, it is to be understood that various number of sets of holes can be spaced along the mounting bracket 102.

The mounting system 100 provides improvements over the prior art in that it eliminates the rocking and associated four-bar mode created by the separate bracket systems by replacing the multiple brackets with a single bar-like bracket. Furthermore, the increased surface area provided by the arc-shaped second portion 106 permits various hole configurations for mounting the transition duct 200 to a turbine inlet. That is, the present invention provides a mounting bracket that is interchangeable or customizable depending on the bolting arrangement of the specific turbine inlet to which the transition duct is being mounted. In addition, the single bar-like bracket reduces the risk of misassembly by reducing the quantity of parts in the mounting system and simplifying the overall mounting system.

In one embodiment of the present invention, the first distance D1 is greater than the second distance D2. In an alternate embodiment of the present invention, the second distance D2 is greater than the first distance D1. In yet another embodiment of the present invention, the first distance D1 is generally equal to the second distance D2. The different distances between the hole sets allows for a common transition duct and aft frame to be used in multiple applications where the hole pattern and spacing differs around the inlet to the turbine. Accordingly, only a modified hole position in the mounting bracket is required.

The mounting holes 112 located in the mounting bracket 102 can vary in shape and size depending on the bolting requirements of the turbine inlet. That is, the mounting holes 112 can be oversized in diameter to permit movement of the transition duct and mounting system relative to the turbine inlet. Alternatively the mounting holes can be generally elliptical in orientation and extending in a greater length circumferentially (i.e. towards an adjacent hole). Furthermore, as shown in FIG. 4, the generally elliptical mounting holes 112 can instead extend in a generally radial direction. This configuration also permits movement of the mounting bracket relative to the turbine inlet to compensate for any alignment issues.

The mounting system 100 is typically used in conjunction with a transition duct 200. The transition duct 200 is formed from a panel assembly 202 that is fabricated from a first panel 204 and a second panel 206, where the first and second panels are secured together along a seam 208. The transition duct 200 has a generally cylindrical inlet end (not shown) and a generally rectangular aft frame 210. The aft frame 210 includes a plurality of retention lugs 212 having circumferential slots by way of which the aft frame 210 can circumferentially expand due to thermal growth. Brackets 214 and 216 are secured to the aft frame 210 by way of fasteners 218. Similar brackets are located along the inner portion of the aft frame 210.

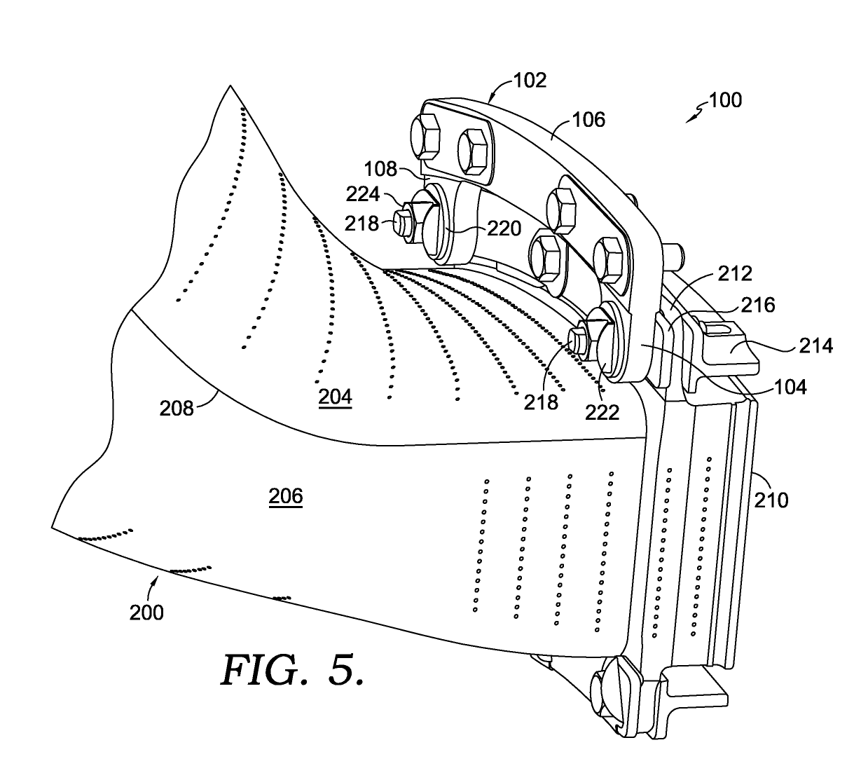

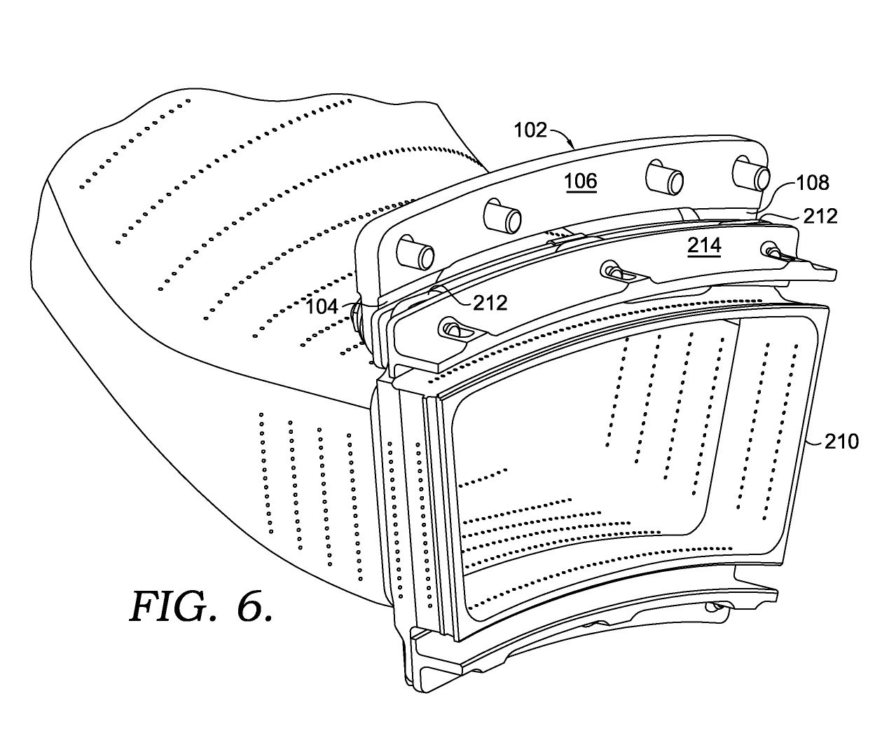

Once the brackets 214 and 216 are mounted to the aft frame 210, the mounting system 100 can be assembled to the panel assembly 202 and aft frame 210. The mounting system 100 is attached to the aft frame region 210 by sliding the mounting bracket 102 onto the fasteners 218 such that fasteners 218 pass through the spherical bearings 110. A washer 220, anti-rotation clip 222, and nut 224 are then placed on or through the fastener. The fastener 218 is then secured by tightening the fastener to the nut 224. Once the fastener 218 is tightened, tabs of the anti-rotation clip are bent to prevent rotation of the nut 224, as shown in FIG. 5. As shown in FIG. 6, the transition duct 200, when in its assembled condition, has a set of fasteners 226 extending through the plurality of sets of mounting holes 112 a distance sufficient to engage an inlet region of a turbine.

The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and sub-combinations are of utility and may be employed without reference to other features and sub-combinations. This is contemplated by and within the scope of the claims.

What is claimed is:

1. A mounting system for a gas turbine transition duct comprising:
a generally C-shaped mounting bracket having a generally radially extending first portion, an arc-shaped second portion, and a generally radially extending third portion;
a spherical bearing located within both the first portion and third portion; and
a plurality of sets of mounting holes located along the second portion of the mounting bracket.

2. The mounting system of claim 1, wherein the spherical bearings permit pivoting of the mounting bracket relative to the transition duct.

3. The mounting system of claim 1, wherein the plurality of sets of mounting holes comprises a first set and second set, with the mounting holes of the first set spaced a first distance apart and the mounting holes of the second set spaced a second distance apart.

4. The mounting system of claim 3, wherein the first distance is greater than the second distance.

5. The mounting system of claim 3, wherein the second distance is greater than the first distance.

6. The mounting system of claim 3, wherein the first distance is generally equal to the second distance.

7. The mounting system of claim 1, wherein the mounting holes have a generally elliptical shape.

8. A transition duct comprising:
a panel assembly comprising a first panel secured to a second panel and having a generally cylindrical inlet end and a generally rectangular outlet end;
an aft frame secured to the outlet end having a plurality of retention lugs;
a mounting system for a gas turbine transition duct comprising:
a generally C-shaped mounting bracket having a generally radially extending first portion, an arc-shaped second portion, and a generally radially extending third portion;
a spherical bearing located within both the first portion and third portion;
a plurality of sets of mounting holes located along the second portion of the mounting bracket;
a plurality of fasteners extending through a plurality of mounting holes in the arc-shaped second portion.

9. The transition duct of claim 8 wherein the plurality of sets of mounting holes in the arc-shaped portion comprises a first set and a second set, with the mounting holes of the first set spaced a first distance apart and the mounting holes of the second set spaced a second distance apart.

10. The transition duct of claim 9, wherein the first distance is greater than the second distance.

11. The transition duct of claim 9, wherein the second distance is greater than the first distance.

12. The transition duct of claim 9, wherein the first distance is generally equal to the second distance.

13. The transition duct of claim 8, wherein the panel assembly further comprises a plurality of rows of cooling holes extending through a panel thickness.

14. The transition duct of claim 8, wherein the mounting bracket is fabricated from a different material than that of the panel assembly.

15. The mounting system of claim 8, wherein the mounting bracket is interchangeable to allow for the transition duct to be secured to different turbine mounting configurations.

16. A mounting bracket for a gas turbine transition duct comprising:
a generally C-shaped mounting bracket having a generally radially extending first portion, an arc-shaped second portion, and a generally radially extending third portion;
a spherical bearing located within both the first portion and third portion;
a first set of mounting holes located along the second portion of the mounting bracket; and
a second set of mounting holes located along the second portion of the mounting bracket;
wherein the first set of mounting holes are spaced a first distance apart and the second set of mounting holes are spaced a second distance apart.

17. The mounting system of claim 16, wherein the first distance is greater than the second distance.

18. The mounting system of claim 16, wherein the second distance is greater than the first distance.

19. The mounting system of claim 16, wherein the first distance is generally equal to the second distance.

20. The mounting system of claim 16, wherein the first set and second set of mounting holes are generally elliptical and extend in a generally radially outward direction.
